(19) United States
(12) Patent Application Publication
(10) Pub. No.: US 2024/0428137 A1
(43) Pub. Date: Dec. 26, 2024

(54) Typicality of Batches for Machine Learning

(71) Applicant: Google LLC, Mountain View, CA (US)

(72) Inventors: Elad Edwin Tzvi Eban, Sunnyvale, CA (US); Alan Mackey, Mountain View, CA (US); Piotr Zielinski, New Providence, NJ (US)

(21) Appl. No.: 18/750,814

(22) Filed: Jun. 21, 2024

Related U.S. Application Data
(60) Provisional application No. 63/509,332, filed on Jun. 21, 2023.

(51) Int. Cl. G06N 20/00

(52) U.S. Cl. CPC G06N 20/00

(57) ABSTRACT

Systems and methods described herein can improve typicality of batches for machine learning. The systems and methods can include obtaining a corpus of training data, the corpus of training data including one or more training examples. The systems and methods can include generating a first batch set including a plurality of batches from the corpus of training data, each of the batches including a subset of the one or more training examples. The systems and methods can include determining a batch distribution of a first batch of the first batch set. The systems and methods can include determining that the first batch is an atypical batch based on the batch distribution of the first batch. The systems and methods can include, in response to determining that the first batch is an atypical batch, shuffling the training examples of the first batch and one or more second batches of the first batch set to generate a second batch set. The systems and methods can include training a first machine-learned model using the second batch set.

### RELATED APPLICATIONS

This application claims priority to and the benefit of U.S. Provisional Patent Application No. 63/509,332, filed Jun. 21, 2023. U.S. Provisional Patent Application No. 63/509,332 is hereby incorporated by reference in its entirety.

### FIELD

The present disclosure relates generally to training machine-learned models. More particularly, the present disclosure relates to improving typicality of batches of training examples used in training machine-learned models.

### BACKGROUND

Machine-learned models are trained over training examples to perform some computational function. For instance, a training process can optimize parameters of the machine-learned model to best reflect the training examples. In some cases, training examples are separated into batches to facilitate training. Imbalances in these training example batches can negatively impact model training.

### SUMMARY

Aspects and advantages of embodiments of the present disclosure will be set forth in part in the following description, or can be learned from the description, or can be learned through practice of the embodiments.

One aspect of the present disclosure is directed to a computer-implemented method for training a machine-learned model. The computer-implemented method can include obtaining, by a computing system including one or more computing devices, a corpus of training data, the corpus of training data including one or more training examples. The computer-implemented method can include generating, by the computing system, a first batch set including a plurality of batches from the corpus of training data, each of the batches including a subset of the one or more training examples. The computer-implemented method can include determining, by the computing system, a batch distribution of a first batch of the first batch set. The computer-implemented method can include determining, by the computing system, that the first batch is an atypical batch based on the batch distribution of the first batch. The computer-implemented method can include, in response to determining that the first batch is an atypical batch, shuffling, by the computing system, the training examples of the first batch and one or more second batches of the first batch set to generate a second batch set. The computer-implemented method can include training, by the computing system, a first machine-learned model using the second batch set.

Another example aspect is directed to a computing system. The computing system can include one or more processors and one or more non-transitory, computer-readable media storing instructions that, when implemented, cause the one or more processors to perform operations. The operations can include obtaining a corpus of training data, the corpus of training data including one or more training examples. The operations can include generating a first batch set including a plurality of batches from the corpus of training data, each of the batches including a subset of the one or more training examples. The operations can include determining a batch distribution of a first batch of the first batch set. The operations can include determining that the first batch is an atypical batch based on the batch distribution of the first batch. The operations can include, in response to determining that the first batch is an atypical batch, shuffling the training examples of the first batch and one or more second batches of the first batch set to generate a second batch set. The operations can include training a first machine-learned model using the second batch set.

Another aspect of the present disclosure is directed to one or more non-transitory, computer-readable media storing instructions that, when implemented, cause one or more processors to perform operations. The operations can include obtaining a corpus of training data, the corpus of training data including one or more training examples. The operations can include generating a first batch set including a plurality of batches from the corpus of training data, each of the batches including a subset of the one or more training examples. The operations can include determining a batch distribution of a first batch of the first batch set. The operations can include determining that the first batch is an atypical batch based on the batch distribution of the first batch. The operations can include, in response to determining that the first batch is an atypical batch, shuffling the training examples of the first batch and one or more second batches of the first batch set to generate a second batch set. The operations can include training a first machine-learned model using the second batch set.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs machine-learning according to example embodiments of the present disclosure.

FIG. 1B depicts a block diagram of an example computing device that performs machine-learning according to example embodiments of the present disclosure.

FIG. 1C depicts a block diagram of an example computing device that performs machine-learning according to example embodiments of the present disclosure.

FIG. 2 depicts a block diagram of an example machine-learned model according to example embodiments of the present disclosure.

FIG. 3 depicts a diagram of training data distributions according to example embodiments of the present disclosure.

FIG. 4 depicts a diagram of shuffling training examples according to example embodiments of the present disclosure.

FIG. 5 depicts a diagram of an example system for training a machine-learned model according to example embodiments of the present disclosure.

FIG. 6 depicts a flow chart diagram of an example method to train a machine-learned model according to example embodiments of the present disclosure.

FIG. 7 depicts a flow chart diagram of an example method to perform shuffling training examples of a first batch and one or more second batches of a batch set according to example embodiments of the present disclosure.

FIG. 8 depicts a flow chart diagram of an example method to perform shuffling training examples of a first batch and one or more second batches of a batch set according to example embodiments of the present disclosure.

Reference numerals that are repeated across plural figures are intended to identify the same features in various implementations.

### DETAILED DESCRIPTION

### Overview

Generally, the present disclosure is directed to ensuring typicality of batches of training examples used in training machine-learned models. A machine-learned model can be trained over a corpus of training data to predict solutions to algorithmic problems. For instance, machine-learned models can be trained to classify data into discrete categories, extrapolate data beyond an original set of training data, generate novel items based on patterns learned from the training data, and various other advanced computational tasks.

However, training a machine-learned model is not a computationally trivial task. Training machine-learned models commonly involves several iterations over thousands or even millions of training examples, depending on the problem. It can be computationally intractable to train machine-learned models on an entire corpus of training data at once. As such, machine-learned models are frequently trained over batches of training examples. Furthermore, due to size and memory constraints and requirements, many machine-learned models are trained with small batches, such as batches with as few as eight training examples. As used herein, a small batch can refer to any suitable batch, such as batches having a batch size of less than about thirty-two.

While smaller batches provide advantages regarding computing resource usage during the training process, smaller batches can result in larger variances in the gradient due to imbalances in the batch distributions. For example, atypical batches such as batches largely or entirely belonging to some homogenous population of the training data are statistically likely to occur over a large corpus of training data divided into small batches. As one example, a model trained with 1 million training steps and batch size eight is extremely likely to observe an entire batch sampled from some 5% of the training data (e.g., eight examples from the same class, such as eight cats in an animal classifier model). As another example, this model is extremely likely to observe a batch with a majority of the elements belonging to some 1% of the training data (e.g., in an animal classifier model, five or more white cats). These atypical batches can negatively impact the training process, especially in the case of non-convex optimization that is close to criticality. For instance, these atypical batches can negatively impact quality, speed, and/or stability of the training process.

Existing solutions to this problem assume that atypical batches are unavoidable and focus on mitigating damage from these atypical batches by techniques such as reduced learning rate and gradient clipping. However, these approaches introduce undesirable biases and effects into the training process. For example, reduced learning rate greatly slows down the training process. In addition, gradient clipping distorts the gradient in the case of atypical batches, which can introduce inaccuracies into the model, especially over a large set of examples. Furthermore, in many cases, computing the gradient for a given batch is a costly process. As such, it is computationally expensive to simply identify and discard atypical batches.

Systems and methods according to the present disclosure provide an improved solution for ensuring typicality of batches for machine-learning. In particular, the present disclosure provides a batch shuffling approach that reshuffles atypical batches with a number of other batches to create more balanced batches, especially small batches. Furthermore, the approaches according to the present disclosure can utilize existing data representations to determine whether a batch is typical or atypical, which can reduce computational resource wastage associated with computing gradients for atypical batches.

According to example aspects of the present disclosure, a computing system can obtain a corpus of training data including one or more training examples. The computing system can generate a first batch set including a plurality of batches from the corpus of training data. Each of the batches can include a subset of the one or more training examples. For instance, the first batch set can be a batch set generated by randomly allocating, slicing, or otherwise distributing the corpus of training data into the plurality of batches. Each of the plurality of batches can have a common batch size.

The computing system can determine a batch distribution of a first batch of the first batch set. The batch distribution can reflect the distribution of the training examples in the first batch. For instance, the batch distribution can have a mean and covariance representing the spread of training data in the batch. Determining the batch distribution can be computationally difficult, because the training data may be unlabeled or uncategorized such that information about the training data is not readily available. For instance, the batch distribution is often based on a solution to the problem that the machine-learned model is attempting to solve, especially in the case of unsupervised learning. Consider, for example, determining class distributions for training data when those classes are unknown.

According to example aspects of the present disclosure, the computing system can determine the batch distribution of the first batch based on existing representations of the corpus of training data. As used herein, an “existing representation” of the corpus of training data refers to any representation of the corpus of training data, including the corpus of training data itself, that is derivable from the corpus of training data by an approach other than the use of the machine-learned model to be trained. As another example, an existing representation of the corpus of training data can be knowable at the time of training the machine-learned model. For instance, the existing representation may be known, derived, or learned by an approach that is less computationally intensive than training the machine-learned model and prior to training the machine-learned model. The existing representation(s) may be related to, but not necessarily identical to, eventual outputs of the machine-learned model.

One example of existing representations of the corpus of training data includes outputs of a second machine-learned model in response to receiving as input the corpus of training data. For instance, the second machine-learned model can generate outputs that are useful for identifying atypical distributions in the batches of training data. The second machine-learned model can perform a similar or even identical task to the first machine-learned model. For instance, the second machine-learned model may be a prior version of the first machine-learned model, such that the outputs from the second machine-learned model are reflective of the eventual outputs of the first machine-learned model and therefore useful for determining distributions in the training data. As another example, the second machine-learned model may be a model that performs a more general version of the task performed by the first machine-learned model. As one example, if the first machine-learned model is trained for a specific classification task, the second machine-learned model may perform a more general classification task. As another example, if the first model is a semantic analysis model trained on a specific category of speech, the second model may be a general or off-the-shelf semantic analysis model. Thus, the second machine-learned model can be useful for identifying atypical batches, even if the first machine-learned model will ultimately have improved accuracy, efficiency, specificity, etc. compared to the second machine-learned model.

The computing system can then determine that the first batch is an atypical batch based on the batch distribution of the first batch. For instance, in some implementations, the computing system can compare the batch distribution of the first batch to a corpus distribution representing the corpus of training data. For instance, in one example implementation, the computing system can determine a typicality score for the first batch based on a similarity between the corpus distribution and the batch distribution of the first batch. The computing system can determine whether the first batch is an atypical batch based on the typicality score. For instance, the typicality score can be compared to a typicality score threshold that, if satisfied, indicates that the batch is typical. One example typicality score is based on a divergence, such as a Kullback-Leibler (KL) divergence, between the batch distribution and the corpus distribution. Although the batch distribution of the first batch does not necessarily have to exactly match the corpus distribution, a highly dissimilar batch distribution can reflect an atypical batch. For example, if a batch distribution is highly skewed towards a subset of training data reflecting some commonality (e.g., a common class) that is not present in the overall training data, training the machine-learned model on that batch may negatively impact the performance of the machine-learned model.

In response to determining that the first batch is an atypical batch, the computing system can shuffle the training examples of the first batch and one or more second batches of the first batch set to generate a second batch set. The computing system can then train the machine-learned model using the second batch set. For instance, in some implementations, the computing system can aggregate and redistribute the training examples in the first batch and the second batches to disperse the atypical homogeneity of the first batch across a larger set of batches, which can desirably improve the overall typicality of the batches. As another example, in some implementations, the computing system can randomly swap one or more training examples between two or more batches to generate the second batch set.

In some implementations, the computing system can shuffle the training examples more than once to improve typicality of the batches. For example, if the computing system that the corresponding batch in the second batch set is still atypical, the computing system can reshuffle the second batch set (e.g., until the corresponding batch is typical). In some implementations, the computing system may increase the number of batches included in the shuffling (e.g., increase a number of second batches) with each consecutive reshuffle.

Example aspects of the present disclosure provide for a number of technical effects and benefits, including improvements to computing technologies. For instance, systems and methods according to example aspects of the present disclosure can determine a batch distribution of a first batch, determining that the first batch is an atypical batch based on the batch distribution, shuffle the training examples of the first batch and one or more second batches of the first batch set to generate a second batch set, and train a machine-learned model using the second batch set. Shuffling the training examples of the first (atypical) batch and the second batches can disperse the concentrated examples across a larger set of batches, which can improve heterogeneity of the second batch set compared to the first batch set. This, in turn, can reduce variance in the gradients determined from the second batch set during training of the machine-learned model. As a result, the training process for the machine-learned model is improved by avoiding the detrimental effects to quality, speed, and stability resulting from training over the atypical batches.

Furthermore, according to example aspects of the present disclosure, existing representations of the training data can be used for determining that the first batch is an atypical batch, such as for determining the batch distribution, which can reduce computational resource wastage associated with determining the gradient for atypical batches. In particular, using the existing representations of a batch, such as model outputs from a prior version of the machine-learned model or from a different model that performs a similar task in response to receiving the batch as input, can be cheaper to determine and use than a gradient for the batch while still adequately representing the distribution for the batch.

With reference now to the Figures, example embodiments of the present disclosure will be discussed in further detail.

### Example Devices and Systems

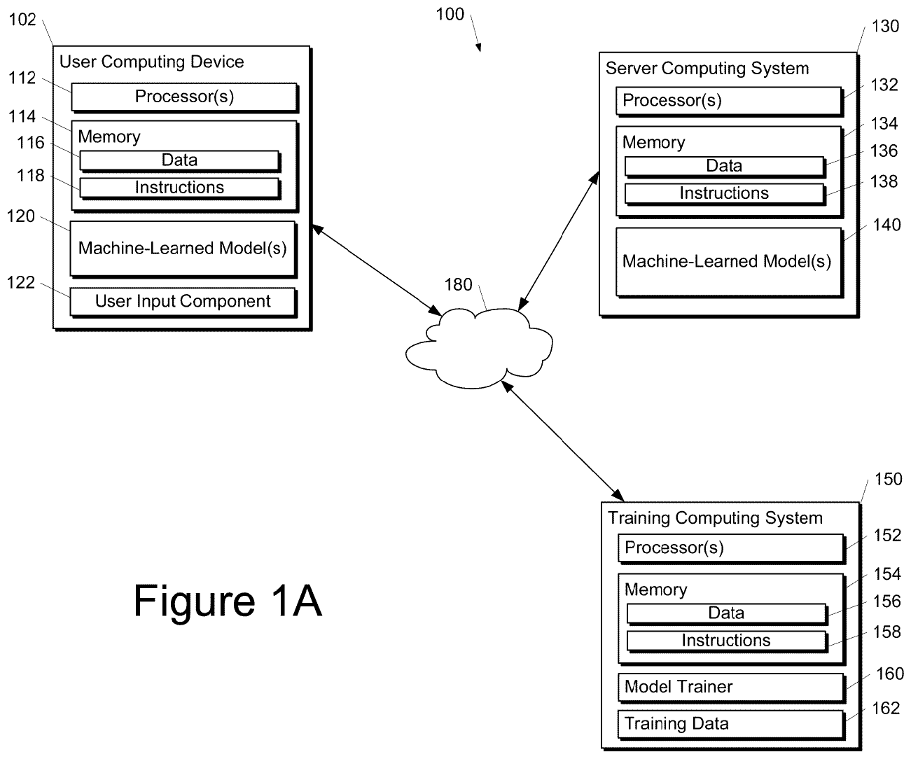

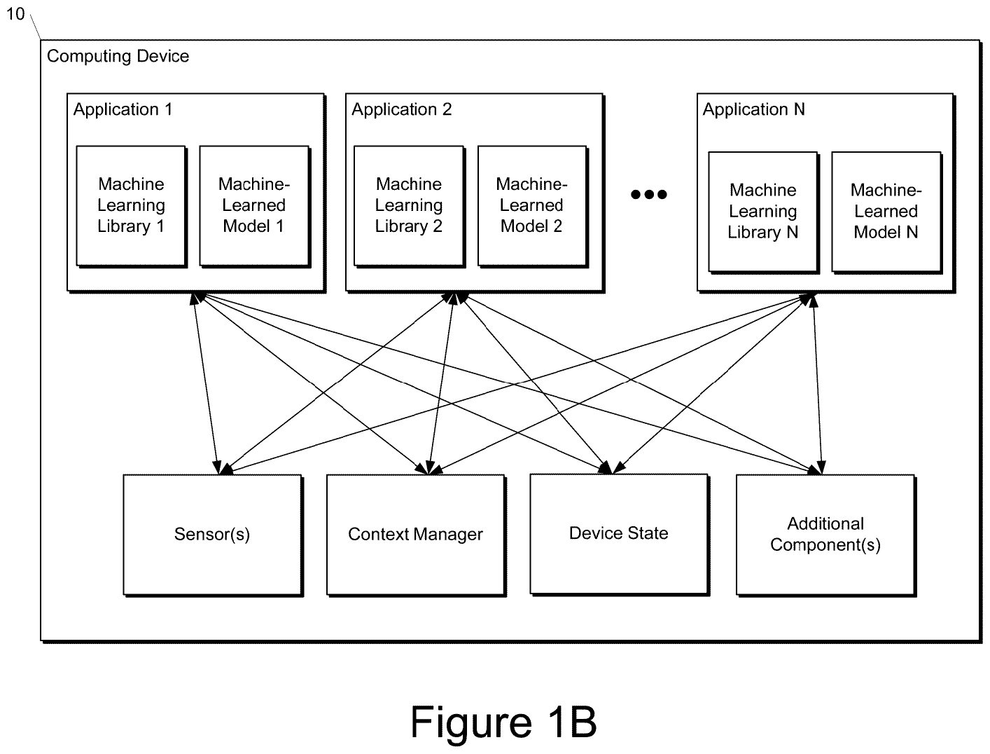

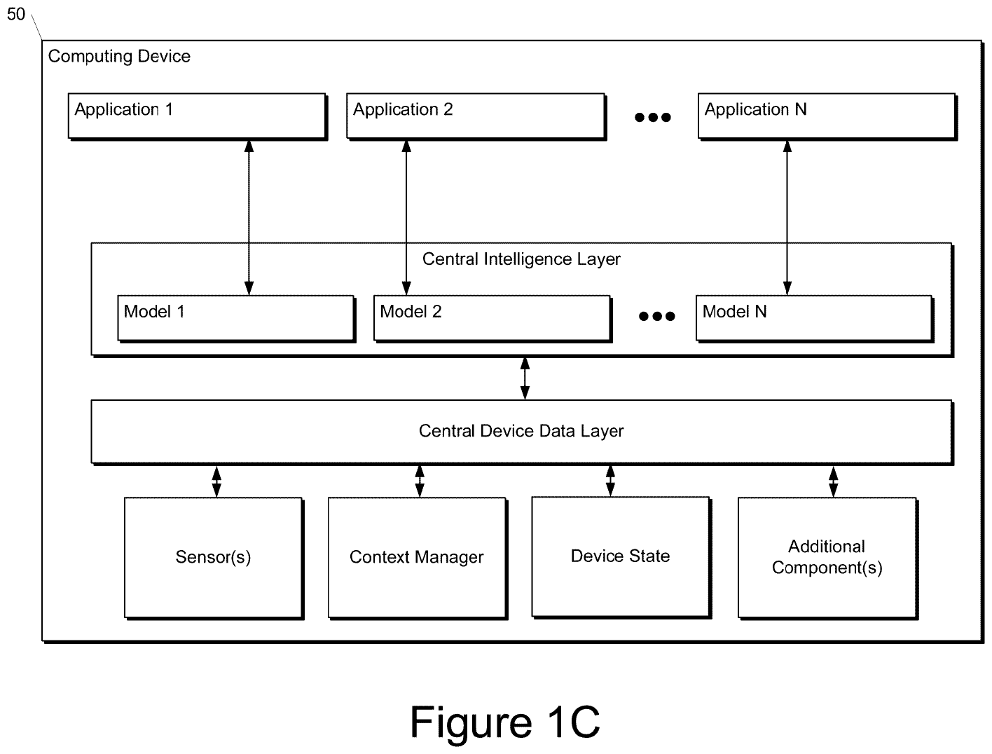

FIG. 1A depicts a block diagram of an example computing system 100 that performs machine-learning according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, a corpus of training data. The training data 162 can be partitioned into a plurality of batches. The batches can be small batches, such as batches having a batch size of less than sixteen training examples per batch.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the user computing device 102 can include the model trainer 160 and the training data 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs machine-learning according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs machine-learning according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

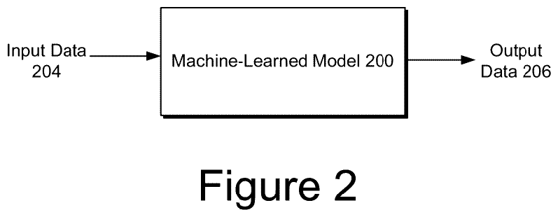

FIG. 2 depicts a block diagram of an example machine-learned model 200 according to example embodiments of the present disclosure. In some implementations, the machine-learned model 200 is trained to receive a set of input data 204 and, as a result of receipt of the input data 204, provide output data 206 that predicts an output according to a computational task based on the input data 204. For instance, the output data 206 can include a classification for the input data 204, a generative output based on the input data 204, and/or any other suitable types of output.

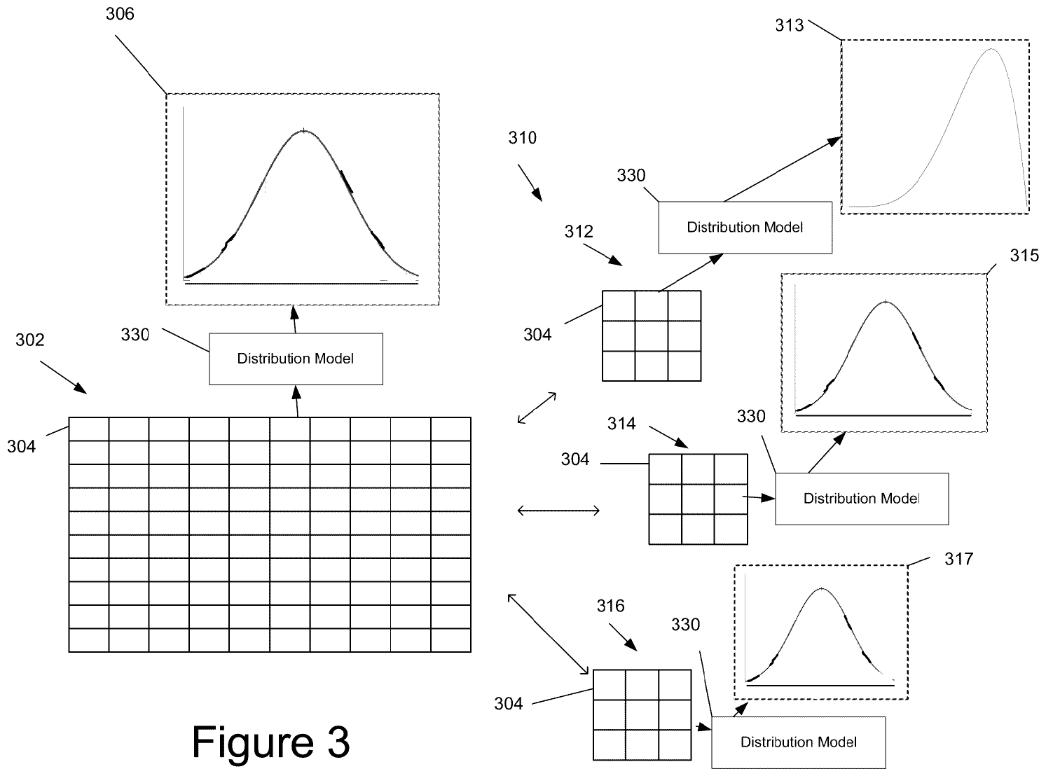

FIG. 3 depicts a diagram of training data distributions according to example embodiments of the present disclosure. In particular, a corpus of training data 302 can include a plurality of training examples 304. The training examples 304 can include data having some characteristic over which a corpus distribution 306 exists. The characteristic can be, for example, a ground truth output associated with a machine-learned model when the example 304 is input to the machine-learned model. The characteristic may or may not be known for the corpus of training data 302. For instance, if the corpus 302 includes supervised data, the examples 304 may be labeled with appropriate ground truth outputs. If, however, the corpus 302 includes unsupervised data, the examples 304 may not be labeled with data over which the corpus distribution 306 can be generated.

To train a machine-learned model, the corpus of training data 302 can be partitioned into a first batch set 310 including a plurality of batches 312, 314, 316. It should be understood that a corpus of training data can include thousands and even millions of training examples and may be partitioned into greater than three batches. For instance, a corpus may be partitioned into small batches having fewer than sixteen training examples 304 per batch, which may produce thousands or millions of batches in a batch set. Each of the batches 312, 314, 316 can include a plurality of training examples 304.

Furthermore, each of the batches in the first batch set 310 can have an associated batch distribution. For instance, first batch distribution 313 can be associated with first batch 312. Similarly, second batch distribution 315 can be associated with second batch 314 and/or third batch distribution 317 can be associated with third batch 316. The batch distributions 313, 315, 317 reflect the makeup of their respective batch. As illustrated in FIG. 3, the first batch 313 can be an atypical batch having a first batch distribution 315 that differs from the batch distribution 306. It should be understood that the visual similarity or difference of batch distributions is not necessarily an indicator of batch typicality or atypicality, and is used herein for the purposes of illustration.

If the distributions 306, 313, 315, 317 are not readily available (e.g., in the case of unsupervised data), a distribution model 330 can generate existing representations of the corpus of training data 302 and/or the batches 310 that can be used to determine the distributions. For instance, the distribution model 330 can be a machine-learned model. If the corpus of training data 302 will be used to train a machine-learned model, that model can be different from the distribution model 330. For instance, the distribution model 330 can produce the existing representation in response to receiving the examples 304 as input. As one example, the existing representation can be an embedding, a classification, a compressed representation, or other suitable representation produced by a distribution model 330. In some implementations, the distribution model 330 can be configured to perform a similar task to the machine-learned model that will be trained using the corpus of training data 302. As one example, the distribution model 330 and the machine-learned model can be configured for a common task, such as an image classification task, a regression task, or other suitable task. Although the machine-learned model and the distribution model 330 can perform a common task, they can nonetheless be distinct models. Generally, the outputs of the first machine-learned model and the distribution model 330 can have enough commonality such that outputs of the distribution model 330 can be somewhat correlated to outputs of the first machine-learned model.

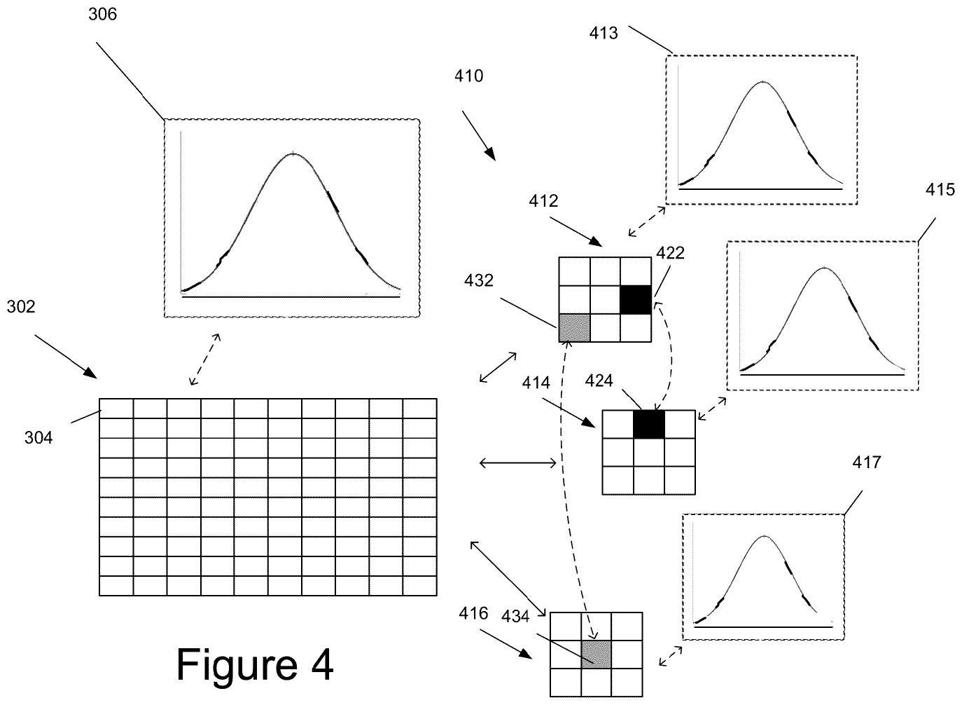

FIG. 4 depicts a diagram of shuffling training examples according to example embodiments of the present disclosure. For instance, FIG. 4 depicts how the first batch set 310 can be shuffled into a second batch set 410 having batches 412, 414, and 416, each with respective distributions 413, 415, and 417. For instance, in the example of FIG. 4, training examples 422 and 424 are swapped between batches 412 and 414 and training examples 432 and 434 are swapped between batches 412 and 416. As illustrated, the batches in second batch set 410 have distributions that each somewhat reflect the corpus distribution 306 and are not atypical. For instance, swapping some examples from the more-homogenous first batch 412 with the less-homogenous batches 414 and 416 can improve the degree to which the first batch 412 matches the corpus distribution 306. In this way, the second batch set 410 can provide improved training characteristics for a machine-learned model.

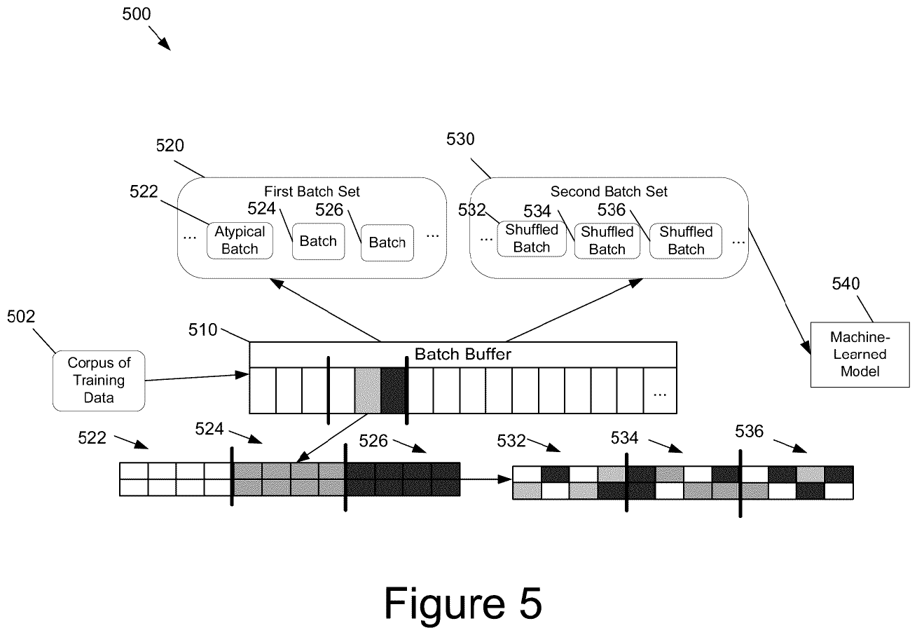

FIG. 5 depicts a diagram of an example system 500 for training a machine-learned model 540 according to example embodiments of the present disclosure. The system 500 can obtain a corpus of training data 502. The system 500 can populate a batch buffer 510 using the corpus of training data 502. For instance, the batch buffer 510 can partition the training examples of the corpus 502 into a first batch set 520, which can be stored in the batch buffer 510 at a first point in time. The first batch set 520 can include batches 522, 524, and 526, of which batch 522 is an atypical batch.

The system 500 can determine that the first batch 522 is an atypical batch as described herein. In response to determining that the first batch 522 is an atypical batch, the system 500 can shuffle the training examples of the first batch 522 with one or more second batches (e.g., batches 524, 526) to produce a second batch set 530. For instance, the batch buffer 510 can overwrite the first batch set 520 with the second batch set 530. The second batch set 530 can include shuffled batches 532, 534, and 536. The shuffled batches 532, 534, 536 can have no atypical batches. The second batch set 530 can then be used to train the machine-learned model 540. Although two batches are shuffled with the atypical batch in the example illustrated in FIG. 5, it should be understood that the atypical batch can be shuffled with more or fewer batches without departing from the present disclosure.

### Example Methods

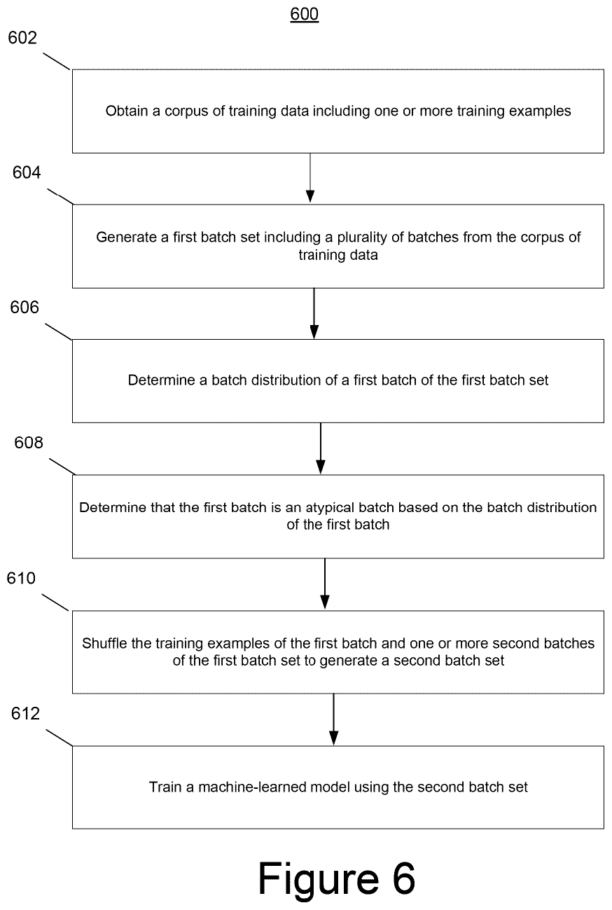

FIG. 6 depicts a flow chart diagram of an example method 600 to train a machine-learned model according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, a computing system can obtain a corpus of training data. The corpus of training data can include one or more training examples. Example aspects of the present disclosure contemplate any suitable form and manner of training data. For instance, the corpus of training data can include labeled data, such as data labeled with an expected output. Additionally or alternatively, the corpus of training data can include unlabeled data. The data can be, for example, images, audio files, video files, numerical data, statistical data, embedding data, natural language data, speech data, text data, and/or any other suitable data.

At 604, the computing system can generate a first batch set including a plurality of batches from the corpus of training data. Each of the batches can be or can include a subset of the one or more training examples. For instance, in some implementations, the computing system can partition the corpus of training data into a plurality of (e.g., equally-sized) batches. The batches can be small batches, such as batches having a batch size of less than sixteen training examples per batch. The computing system can generate the first batch set by any suitable manner, such as randomly partitioning the corpus of training data, splitting the corpus of training data according to an ordering of the corpus of training data, or any other suitable manner.

At 606, the computing system can determine a batch distribution of a first batch of the first batch set. According to example aspects of the present disclosure, determining the batch distribution of the first batch can be based on existing representations of the corpus of training data. For instance, in some implementations, the existing representations of the corpus of training data can include outputs of a second machine-learned model in response to receiving as input the corpus of training data. For instance, the second machine-learned model can produce the existing representation of the corpus of training data in response to receiving the corpus of training data (or portion thereof) as input. As one example, the existing representation can be an embedding, a classification, a compressed representation, or other suitable representation produced by a second machine-learned model. In some implementations, the second machine-learned model can be configured to perform a similar task to the first machine-learned model. As one example, the second machine-learned model and the first machine-learned model can be configured for a common task, such as an image classification task, a regression task, or other suitable task.

Although the first machine-learned model and the second machine-learned model can perform a common task, they can nonetheless be distinct models. Generally, the outputs of the first machine-learned model and the second machine-learned model can have enough commonality such that outputs of the second machine-learned model can be somewhat correlated to outputs of the first machine-learned model. In this manner, the outputs of the second machine-learned model can serve as an effective “pseudo-truth” for determining the distribution of the first batch without requiring costly algorithms to determine the true distribution of the first batch, when the distribution is unavailable. In some example implementations, the second machine-learned model can be or can include a prior version of the first machine-learned model. For instance, if a machine-learned model is updated yearly, the second machine-learned model may be a version of the machine-learned model from a prior year.

At 608, the computing system can determine that the first batch is an atypical batch based on the batch distribution of the first batch. An atypical batch can be a batch having some undesirable degree of homogeneity. For example, if a machine-learned model is trained to perform a classification task that classifies data between one of fifty classes and a batch has nearly all of its training examples belonging to a single class, that batch can be an atypical batch.

Furthermore, in some implementations, determining that the first batch is an atypical batch can be performed based on a comparison between a corpus distribution of the corpus of training data and the batch distribution of the first batch. For instance, if the distribution of the first batch differs from the overall distribution of the training data, the first batch may be atypical. As one example, in some implementations, the computing system can further determine a corpus distribution of the corpus of training data. In some implementations, the corpus distribution can be determined based on the entire corpus of training data. Additionally or alternatively, in some implementations, the corpus distribution can be determined based on a subset of the corpus of training data.

In some implementations, determining that the first batch is an atypical batch can be based on a typicality score associated with the first batch. For instance, the typicality score can be a value within a range of values, wherein the range indicates how similar the distribution of the first batch is to the corpus distribution. For instance, in some implementations, determining that the first batch is an atypical batch based on the batch distribution of the first batch can include determining, by the computing system, a typicality score for the first batch based on the batch distribution of the first batch and the corpus distribution. Additionally or alternatively, determining that the first batch is an atypical batch based on the batch distribution of the first batch can include determining that the first batch is an atypical batch based on the typicality score for the first batch.

In some implementations, determining that the first batch is an atypical batch based on the typicality score for the first batch includes comparing the typicality score for the first batch to a typicality score threshold. For instance, the typicality score threshold can be a threshold indicating whether a batch is considered typical or atypical. As an example, the typicality score threshold can have a value falling within a range of possible values of the typicality score. Typicality score values on one side of the typicality score threshold can indicate typical batches and typicality score values on the other side of the typicality score threshold can indicate atypical batches.

In some implementations, the typicality score can be based on a divergence between the batch distribution of the first batch and the corpus distribution. For instance, any suitable divergence can be used to measure a distance or dissimilarity between the batch distribution and the corpus distribution. In some implementations, for example, the divergence can be or can include a Kullback-Leibler (KL) divergence, a Jensen-Shannon divergence, and/or other suitable divergences. In addition to and/or alternatively to divergences, the typicality score can be based on any other suitable manner of determining similarity between distributions, such as, for example, the Kolmogorov-Smirnov test.

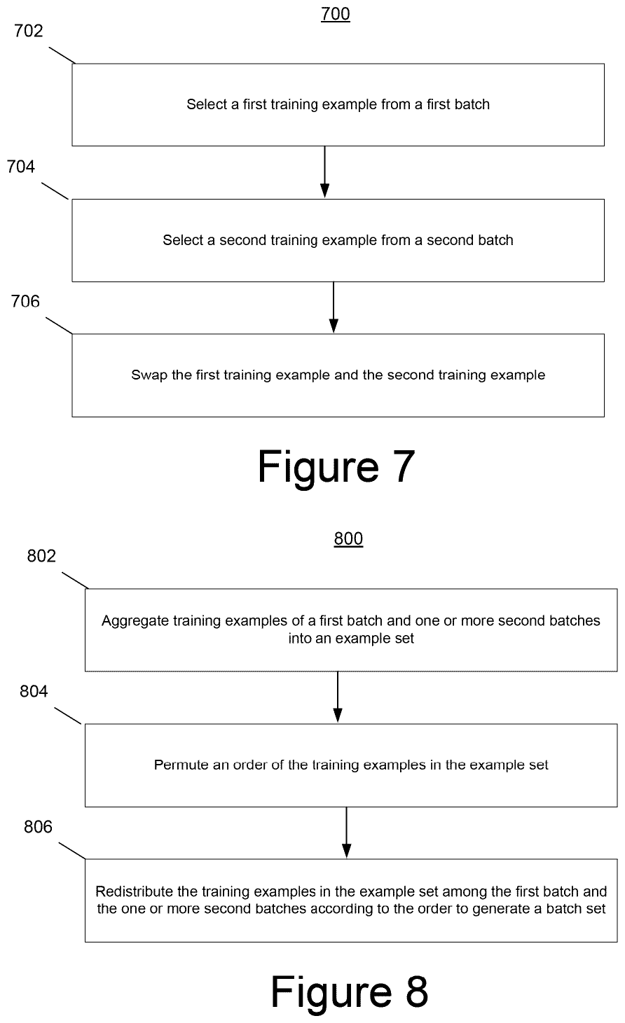

At 610, the computing system can (e.g., in response to determining that the first batch is an atypical batch) shuffle the training examples of the first batch and one or more second batches of the first batch set to generate a second batch set. For instance, the computing system can distribute at least some of the training examples of the first batch among the second batches and/or replace the distributed training examples of the first batch with training examples from the second batches to shuffle the training examples. The shuffled training examples can be recombined into shuffled batches which are ultimately used to generate the second batch set. Two example approaches for shuffling the training examples are described with respect to FIGS. 7 and 8. Any other suitable approaches for shuffling the training examples can be used in accordance with the present disclosure.

At 612, the computing system can train a first machine-learned model using the second batch set. For instance, the second batch set can replace the first batch set for training the first machine-learned model. Each of the batches in the second batch set can be provided to the first machine-learned model as training data over one or more epochs. The first machine-learned model can be trained by various training or learning techniques, such as, for example, backwards propagation of errors. For example, a loss function (e.g., for each batch) can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

FIG. 7 depicts a flow chart diagram of an example method 700 to perform shuffling training examples of a first batch and one or more second batches of a batch set according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can select a first training example from the first batch. The computing system can select the first training example in any suitable manner. As one example, in some implementations, the computing system can randomly select the first training example. As another example, in some implementations, the computing system can select the first training example according to an ordering of the first batch.

At 704, the computing system can select a second training example from a second batch of one or more second batches. As one example, in some implementations, the computing system can randomly select the second training example. As another example, in some implementations, the computing system can select the second training example according to an ordering of the second batch.

At 706, the computing system can swap the first training example and the second training example. For instance, the computing system can store the first training example at a memory location different from the first batch or the second batch. The computing system can then overwrite the first training example at the first batch with the second training example. Finally, the computing system can overwrite the second training example at the second batch with the first training example from the memory location different from the first batch or the second batch.

The method 700 can be repeated one or more times to shuffle multiple training examples among the batches. For example, in some implementations, the computing system can repeat the method 700 until the first batch is no longer determined to be an atypical batch. In this way, the computing system can ensure the typicality of the training data used to train a machine-learned model.

FIG. 8 depicts a flow chart diagram of an example method 800 to perform shuffling training examples of a first batch and one or more second batches of a batch set according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can aggregate the training examples of the first batch and the one or more second batches into an example set. For instance, the example set can store the examples of each of the batches in a permutable structure, such as a tensor. The example set can store the values or data associated with the training example directly, in some implementations. Additionally or alternatively, in some implementations, the example set can store addresses or pointers for the training examples in the example set. At 804, the computing system can permute an order of the training examples in the example set. Furthermore, at 806, the computing system can redistribute the training examples in the example set among the first batch and the one or more second batches according to the order to generate a batch set (e.g., the second batch set). For instance, in some implementations, the computing system can swap positions of one or more training examples in the example set and partition the example set into corresponding batches based on the swapped positions of the training examples. As another example, in some implementations, the computing system can assign training examples to new batches corresponding to the first batch and the one or more second batches.

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for training a machine-learned model, comprising:
obtaining, by a computing system comprising one or more computing devices, a corpus of training data, the corpus of training data comprising one or more training examples;
generating, by the computing system, a first batch set comprising a plurality of batches from the corpus of training data, each of the batches comprising a subset of the one or more training examples;
determining, by the computing system, a batch distribution of a first batch of the first batch set;
determining, by the computing system, that the first batch is an atypical batch based on the batch distribution of the first batch;
in response to determining that the first batch is an atypical batch, shuffling, by the computing system, the training examples of the first batch and one or more second batches of the first batch set to generate a second batch set; and
training, by the computing system, a first machine-learned model using the second batch set.

2. The computer-implemented method of claim 1, wherein:
the method further comprises determining, by the computing system, a corpus distribution of the corpus of training data; and
determining that the first batch is an atypical batch based on the batch distribution of the first batch comprises:
determining, by the computing system, a typicality score for the first batch based on the batch distribution of the first batch and the corpus distribution; and
determining, by the computing system, that the first batch is an atypical batch based on the typicality score for the first batch.

3. The computer-implemented method of claim 2, wherein the typicality score is based on a divergence between the batch distribution of the first batch and the corpus distribution.

4. The computer-implemented method of claim 3, wherein the divergence comprises a Kullback-Leibler (KL) divergence.

5. The computer-implemented method of claim 2, wherein determining that the first batch is an atypical batch based on the typicality score for the first batch comprises comparing the typicality score for the first batch to a typicality score threshold.

6. The computer-implemented method of claim 2, wherein the corpus distribution is determined based on a subset of the corpus of training data.

7. The computer-implemented method of claim 1, wherein determining the batch distribution of the first batch is based on existing representations of the corpus of training data.

8. The computer-implemented method of claim 7, wherein the existing representations of the corpus of training data comprise outputs of a second machine-learned model in response to receiving as input the corpus of training data.

9. The computer-implemented method of claim 8, wherein the second machine-learned model is configured to perform a similar task to the first machine-learned model.

10. The computer-implemented method of claim 8, wherein the second machine-learned model comprises a prior version of the first machine-learned model.

11. The computer-implemented method of claim 1, wherein shuffling the training examples of the first batch and the one or more second batches of the first batch set comprises:
selecting, by the computing system, a first training example from the first batch;
selecting, by the computing system, a second training example from the one or more second batches; and
swapping, by the computing system, the first training example and the second training example.

12. The computer-implemented method of claim 1, wherein shuffling the training examples of the first batch and the one or more second batches to generate the second batch set comprises:
aggregating the training examples of the first batch and the one or more second batches into an example set;
permuting an order of the training examples in the example set; and
redistributing the training examples in the example set among the first batch and the one or more second batches according to the order to generate the second batch set.

13. A computing system, comprising:
one or more processors; and
one or more non-transitory, computer-readable media storing instructions that, when implemented, cause the one or more processors to perform operations comprising:
obtaining a corpus of training data, the corpus of training data comprising one or more training examples;
generating a first batch set comprising a plurality of batches from the corpus of training data, each of the batches comprising a subset of the one or more training examples;
determining a batch distribution of a first batch of the first batch set;
determining that the first batch is an atypical batch based on the batch distribution of the first batch;
in response to determining that the first batch is an atypical batch, shuffling the training examples of the first batch and one or more second batches of the first batch set to generate a second batch set; and
training a first machine-learned model using the second batch set.

14. The computing system of claim 13, wherein:
the operations further comprise determining a corpus distribution of the corpus of training data; and
determining that the first batch is an atypical batch based on the batch distribution of the first batch comprises:
determining a typicality score for the first batch based on the batch distribution of the first batch and the corpus distribution; and
determining that the first batch is an atypical batch based on the typicality score for the first batch.

15. The computing system of claim 14, wherein the typicality score is based on a divergence between the batch distribution of the first batch and the corpus distribution.

16. The computing system of claim 14, wherein determining that the first batch is an atypical batch based on the typicality score for the first batch comprises comparing the typicality score for the first batch to a typicality score threshold.

17. The computing system of claim 13, wherein determining the batch distribution of the first batch is based on existing representations of the corpus of training data, wherein the existing representations of the corpus of training data comprise outputs of a second machine-learned model in response to receiving as input the corpus of training data.

18. The computing system of claim 13, wherein shuffling the training examples of the first batch and the one or more second batches of the first batch set comprises:
selecting a first training example from the first batch;
selecting a second training example from the one or more second batches; and
swapping the first training example and the second training example.

19. The computing system of claim 13, wherein shuffling the training examples of the first batch and the one or more second batches to generate the second batch set comprises:
aggregating the training examples of the first batch and the one or more second batches into an example set;
permuting an order of the training examples in the example set; and
redistributing the training examples in the example set among the first batch and the one or more second batches according to the order to generate the second batch set.

20. One or more non-transitory, computer-readable media storing instructions that, when implemented, cause one or more processors to perform operations comprising:
obtaining a corpus of training data, the corpus of training data comprising one or more training examples;
generating a first batch set comprising a plurality of batches from the corpus of training data, each of the batches comprising a subset of the one or more training examples;
determining a batch distribution of a first batch of the first batch set;
determining that the first batch is an atypical batch based on the batch distribution of the first batch;
in response to determining that the first batch is an atypical batch, shuffling the training examples of the first batch and one or more second batches of the first batch set to generate a second batch set; and
training a first machine-learned model using the second batch set.
